(19) United States
(12) Patent Application Publication
(10) Pub. No.: US 2003/0187664 A1
(43) Pub. Date: Oct. 2, 2003

(54) Method for providing an on-line data collaboration forum

(75) Inventor: John Zachary Bonebrake, Springfield, MO (US)

Correspondence Address: Ladi O. Shogbamimu, SHOOK, HARDY & BACON L.L.P., 1200 Main Street, Kansas City, MO, 64105-2118, US

(73) Assignee: STUDENTFARM INC.

(21) Appl. No.: 10/097,164

(22) Filed: Mar. 13, 2002

(51) Int. Cl. G06F 17/60

(52) U.S. Cl. 705/1

(57) ABSTRACT

The present invention is directed to a system and method for collaboration by a number of entities in an online forum. The present invention provides a site where a first entity can collaborate with one or more other entities, to provide solutions to the project development, management, or other needs of the first entity.

### CROSS-REFERENCE TO RELATED APPLICATIONS

Not applicable

### STATEMENT REGARDING FEDERALLY SPONSORED RESEARCH OR DEVELOPMENT

Not applicable

### TECHNICAL FIELD

The present invention relates generally to network computing environments. More particularly, the present invention relates to a system and method for collaboration by a number of entities in an online forum.

### BACKGROUND OF THE INVENTION

Firms, corporations, individuals, and other business entities often encounter business-related problems that need to be solved. The scope of these problems span a myriad of fields including technical related matters, human resources concerns, new product development needs, or any other areas where attention is warranted. Businesses sometimes attempt to meet their needs internally. If the problem to be solved is unrelated to the business's core competencies, then outsourcing the resolution becomes desirable. Searching and hiring external solution providers is often expensive and time consuming.

Students are a special group within society who study how to solve problems. Especially at the college level, students are typically required to complete some sort of capstone or senior project prior to graduating. Some companies develop unique relationships with certain student groups or schools. These relationships take on the form of internships or co-ops. It is rare, even in these situations, for students to be able to work in a team with other students. Internships and co-ops can fall short of both parties' expectations when the company only provides mundane work to the intern and consequently does not reap the perceived value of the intern. Boring or monotonous assignments can create an unwarranted negative image of the company within the intern's mind.

In rare occasions, a company and student team may partner to form a complementary relationship. In need of a design project to complete, the student team attempts to solve the company's problem in an unbound, uncoordinated environment. While this scheme may result in limited success, the business/student relationship is one-to-one because coordinating the logistics and expenses between multiple parties is prohibitively expensive and time consuming.

A need exists to provide a forum for data collaboration between students and business entities that will forge beneficial relationships, permit problems to be posted, and solutions to be presented in a coordinated, location-independent environment.

### SUMMARY OF THE INVENTION

The present invention provides a site where a first entity can collaborate with one or more other entities, to satisfy the project development, management, or other needs of the first entity.

In one aspect of the invention, an online system—virtual space for people to convene is provided. Solution provider entities can compete against other solution providers or teams over the best solution to a business problem. In the case where the solution providers happen to be students, a business would benefit from the relatively inexpensive solution and the students will gain valuable experience and forge new relationships with professionals.

Within the same case analogy, students could also commit to working on one or more projects in return for a fee from the business entity. The online site can take on the form of a web-site. The web-site can provide a place for students to shop for projects and businesses to shop for students.

In another aspect of the invention, the site would be maintained and operated by an administrator. This administrator would keep the web-site functioning properly and could also act as a moderator between the participant entities.

Additional aspects of invention, together with the advantages and novel features appurtenant thereto, will be set forth in part in the description which follows, and in part will become apparent to those skilled in the art upon examination of the following, or may be learned from the practice of the invention. The aspects and advantages of the invention may be realized and attained by means, instrumentalities and combinations particularly pointed out in the appended claims.

### BRIEF DESCRIPTION OF THE DRAWINGS

In the accompanying drawings which form a part of the specification and are to be read in conjunction therewith, and in which like reference numerals are employed to indicate like parts in the various figures, the present invention is described in detail below with reference to the attached drawing figures, wherein:

FIG. 1 is a diagram depicting the many to many relationship between students, projects, and professionals.

FIG. 2 is a diagram depicting a broad overview of the web-site.

FIG. 3 is a flow chart showing an illustrative sequence a client follows to setup a project. This area is viewable not viewable by students.

FIG. 4 is a block diagram showing the project management area content. This area is viewable not viewable by students.

FIG. 5 is a block diagram showing the current listed projects area content. This area is viewable not viewable by students.

FIG. 6 is a block diagram showing the current running projects area content. This area is viewable not viewable by students.

FIG. 7 is a block diagram showing the current student details area content. This area is viewable not viewable by students.

FIG. 8 is a block diagram showing the students section area content.

FIG. 9 is a flow chart showing the sequence a student follows in signing up for a project.

FIG. 10 is a block diagram showing the students running project details area content.

### DETAILED DESCRIPTION OF THE INVENTION

The present invention is directed to a system and method for a collaboration site wherein a number of persons and/or entities can describe project requirements, express a desire to participate in one or more projects, present and/or accept proposed project solutions, arrange for and maintain compensation, as well as manage all other aspects associated with a collaborative project. The particular embodiment described herein is intended in all respects to be illustrative rather than restrictive. Alternative embodiments will become apparent to those skilled in the art to which the present invention pertains without departing from its scope.

The present invention will be described with reference to an exemplary embodiment that pertains to a system and method and solutions that provides students with an opportunity to post ideas and solutions to real business problems or projects.

Exemplary Operating Architecture

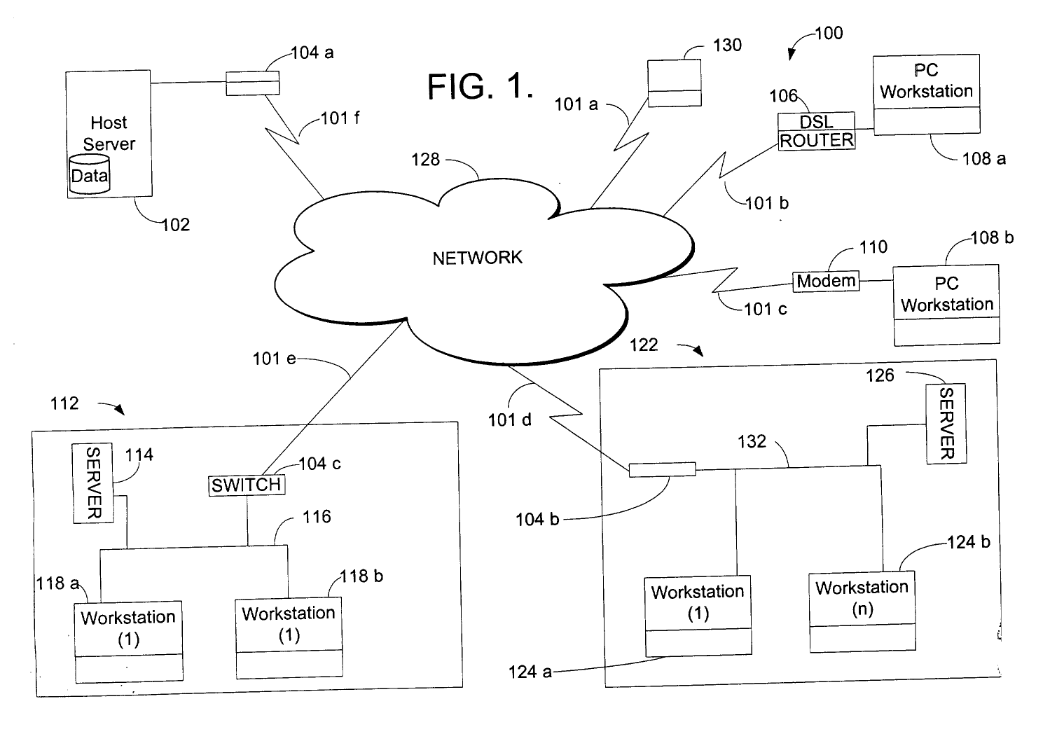

The present invention may be described in the general context of computer-executable instructions, such as program modules, being executed by one or more computing devices in a network environment. Generally a network includes several similar or dissimilar devices connected together by some transport medium, which enables communication between the devices by using a predefined protocol. Those skilled in the art will appreciate that the present invention may be practiced within a variety of network configuration environments and on a variety of computing devices, including hand-held devices, consumer electronics, and the like. The invention may also be practiced in a wireless computing environment. Referring to the drawings in general and initially to FIG. 1 in particular, wherein like reference numerals identify like components in the various figures, an exemplary operating environment for implementing the present invention is shown.

FIG. 1 illustrates a network architecture 100 in which the present invention can be implemented. The network architecture 100 is only one example of a suitable architecture and is not intended to suggest any limitation as to the scope of use or functionality of the invention. Additionally, the network architecture 100 should not be interpreted as having any dependency or requirement relating to any one or combination of components illustrated FIG. 1.

An exemplary network 128 for implementing the invention includes a public or private network, such as the Internet, Virtual Private Network (VPN) or other such arrangement, that enables multiple devices to be locally or remotely interconnected, to facilitate communication between them. The Internet is a network of networks that enables one computing system to access virtually any other computing system and any database and any type of information, anywhere in the world, so long as requisite devices have access to the Internet. VPN otherwise referred to as a Software-Defined Network (SDN) is typically used by large user organizations that have sites, which are geographically dispersed. A terminating location in each of a multi-site enterprise is identified and a level of bandwidth required by each is determined. Dedicated access circuits are then established between each point of termination and the closest VPN-capable InterExchange Carrier (IXC) Point Of Presence (POP). This allows the routing of communication traffic over specified high-capacity transmission facilities on a priority basis, thus creating a level of service equivalent to that of a true private network.

The present invention operates with a variety of connected devices in a network environment, as discussed and illustrated in FIG. 1. In an embodiment of the present invention, a hosting server 102 or multiple servers, provide a central store or repository for the software programs and data required to provide a functional site and more particularly a functional collaboration site. A business organization or school (Customer) 112 or any entity with a need to have a task accomplished or requiring products or services may also be connected to the network. Vendors, solution providers, apprentices, students and other such entities, collectively referred to herein as solution providers (Provider) may also be connected to the network 128. The connection to the network 128 can be made with a variety of hardware, software or any combination of both. These providers 122 could have a single workstation or be part of a LAN 132 that is connected to the network 128. A provider 122 as shown may have a remote connection 101d that is coupled to a switch/router 104. The switch/router 104 is in turn connected to a LAN 132 at the provider's location. As with the Customer 112, the provider 122 may also have a server 126 and multiple client workstations 124a, 124b. Regardless of the intended purpose of the connection, each of the connections discussed above can be accomplished in a variety of ways. Connections can be established in ways including but not limited to dial-up access 101c using a modem 110, broadband connection 101b such as Digital Subscriber Line (DSL) via a DSL router 106, wireless access 101a, or dedicated access 101e such as a T1 line. However, the performance of a connection will depend on the nature of the underlying technologies that are utilized and the amount of available bandwidth that is provided. In all instances of connection types, there is typically a requirement for specific combinations of hardware and software on each end of the communication medium. For example, when using dial-up access via a modem to connect to the Internet, there must be a modem at the client side and a modem on the receiving side of the network. The receiving side of the network for the Internet is usually provided by an Internet Service Provider (ISP). An ISP is an organization that has a bank of modems rated at various speeds to accommodate and match the speed of incoming client modem connections.

The indicated remote connection 101f provides access from the network 128 through a router 104a to a hosting system 102, which may be a single computing device as shown or an array of devices that are interconnected. The hosting system 102, provides access to stored information, databases, and web enabled applications such as applets, portlets, web pages and the like, for use or execution by various other computing devices on the network 128. Computing devices on the network 128 that may be utilized for communicating to the host system 102 may include a wireless device 130 linked by a remote connection 101a, such as a PDA, PC, hand held device or other mobile devices equipped with a wireless interface. The network 128 can also be accessed by client side application programs or browsers executing on a PC 108. The PC 108 may be connected to the network 128 in a variety of ways including but not limited to a hard-wired connection via a Local Area Network (LAN) or a remote connection. An example of such remote connections include the connection 101b from a PC 108a via a DSL Router 106, or the connection 101c from a PC 108b via a dial up modem 110, or any of the other connections configurations previously discussed.

As illustrated, a direct connection 101e may be utilized by the customer 112. Large organizations typically derive a cost-benefit from utilizing a dedicated access connection. A dedicated or direct access connection in this context is a connection to a regional or national backbone provider, bypassing any local ISP. Direct access can be based on a number of alternatives including but not limited to, Dataphone Digital Service (DDS), Trunk Carrier (T-Carrier e.g. Fractional T1, T1, T3, etc.). The connection 101e is linked to a network interface device 104c, which performs the functions of routing and switching between the external network 128 and the network 116 of the E-Business 112. A router is an intelligent device that supports connectivity between like and disparate LANs. Routers can also provide access to various WANs, such as X.25, ISDN and Frame Relay. Routers generally provide connectivity, addressing and switching. As would be understood by those skilled in the art the Hosting Entity for the collaborative site of the business client (custom) can be highly computerized with an enterprise network system as shown in FIG. 1 or simply have a single standalone computer. As shown, a single server 114 or multiple servers are connected on a LAN 116. The server 114 is accessible by any one or more of the network workstation clients 118a, 118b.

As previously stated, the present invention may be described in the general context of computer-executable instructions, such as program modules, being executed by a computer. Generally, program modules include routines, programs, objects, components, data structures, and the like, that perform particular tasks or implement particular abstract data types. Moreover, those skilled in the art will appreciate that the present invention is operational with a variety of additional general purpose or special purpose computing systems, environments, and/or configurations. Examples of well known computing systems, environments, and/or configurations that may be suitable for use with the present invention include, but are not limited to, personal computers, server computers, hand-held or laptop devices, multiprocessor systems, microprocessor-based systems, programmable consumer electronics, network PCs, minicomputers, mainframe computers, and the like. The invention also may be practiced in distributed computing environments wherein tasks are performed by remote processing devices that are linked through a communications network. In a distributed computing environment, program modules may be located in both local and remote computer storage media including memory storage devices.

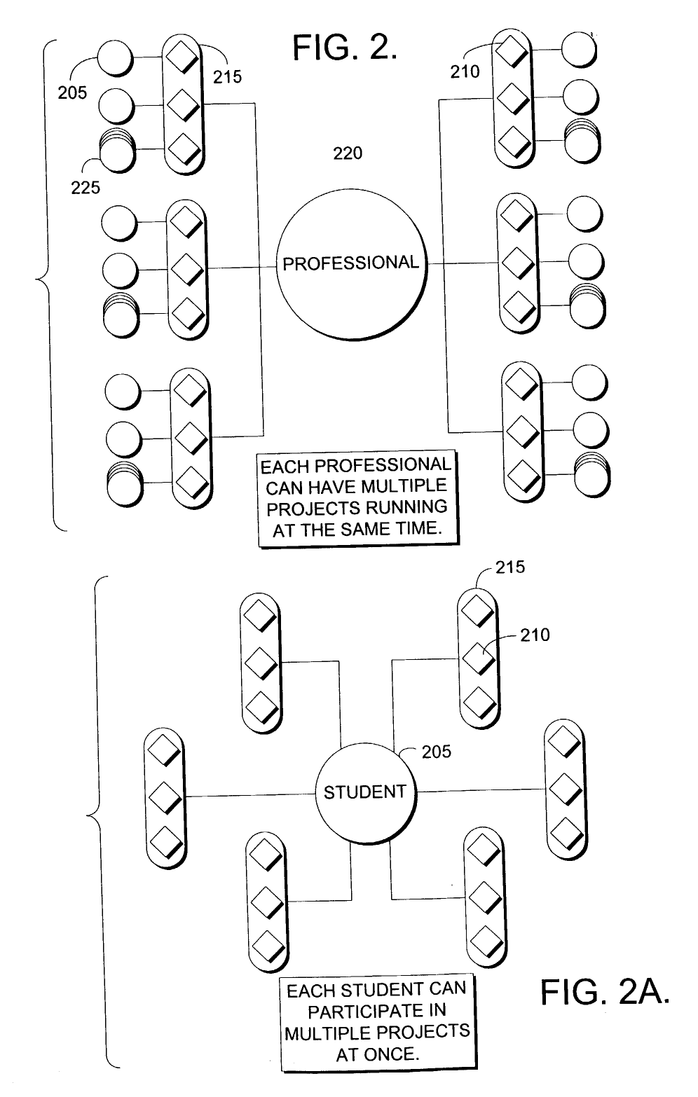

Having discussed an operating environment and exemplary architecture for the present invention, we turn to a discussion on an exemplary implementation of an embodiment of the present invention, in which business professionals are one entity and students are as the other entity. Turning first to FIG. 2, students 205 with ideas are brought together with one or more professionals 220 that have particular problems or projects 215. A collaborative site provides the students 205 with an opportunity to select, participate and post solutions to the projects 215 for review by the professional 220. For the purpose of this discussion professional 220 is an entity that posts projects 215 on the site. Projects 215 can include problems to be solved or issues to be addressed. Although professional 220 would typically be a business, professional 220 can be an individual, volunteer organization, government agency, etc., and include any person or entity that wants feedback on a given project or task. In the illustrative embodiment and as discussed herein, the site could be a project center located at a web-address, the project undertakers or solution providers could be a single student 205 or a team of students 225, and the environment could be a competition between the student teams. As shown, a professional 220 can provide multiple projects 215 on the site at any one time, and have multiple students 205 or team of students 225 working on each of the projects 215.

Having discussed the relationship between a professional 220, the students 205, 225 and the projects 215, we turn next to a discussion of the particular relationship or possibilities relating to a student 205 or teams of students 225, and a variety of projects. This discussion will be with reference to FIG. 2A. As shown in FIG. 2A, each student 205 can participate in one or more projects at one time. Accordingly, a team of students 225 can also participate in more than one project. It should be noted that the project 215 originates from any one of a number of source i.e. multiple professionals.

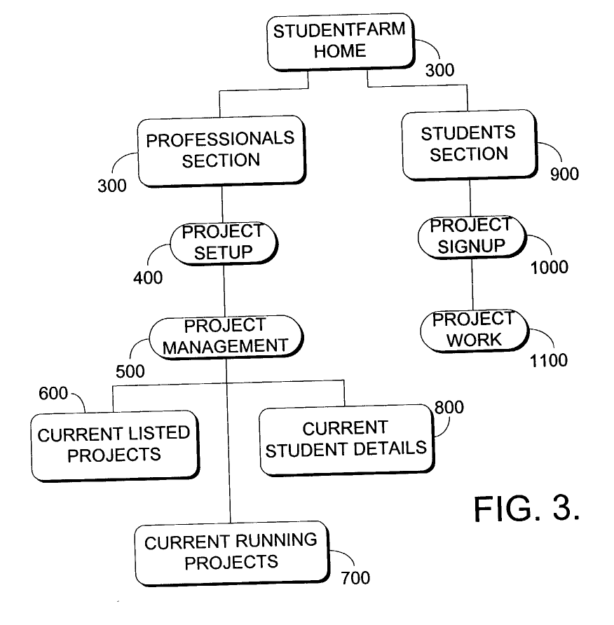

FIG. 3 illustrates the environment and options that facilitate the variety of operations that can be performed with respect to the site, the providers (student), the customers (professional) and the projects. As previously discussed, a site may include the ability for several aspects of the collaborative effort to be defined, edited, reviewed and managed. By way of example and not limitation, the exemplary embodiment of the student and professional paradigm will be used to facilitate an understanding of the present invention. As shown in FIG. 3, starting from a home page or main menu 300, a variety of options exists for each of the two classes of users, namely students and professionals. In the case of a student, there is a student section 900, which allows the student to either, signup for a project by selecting option project signup 1000 or work on a project by selecting project work 1100. Also available but not shown are options for a student to find or start a team of other students. A student also has the ability to access a personalized to do list. In the case of a professional, there is a professional section 300. As illustrated, a professional has the option to define and specify a project by selecting project setup 400, or [s]he may manage various aspects of the project by selection project management 500. Project management as will be discussed later on in detail, incorporates a number of actions including but not limited to selecting to access-current listed projects 600, current running projects and current student details 800. Each of the aforementioned selections available in the student section 900 and the professional section 300 will be discussed in detail later in this document with reference to the operation of the present invention.

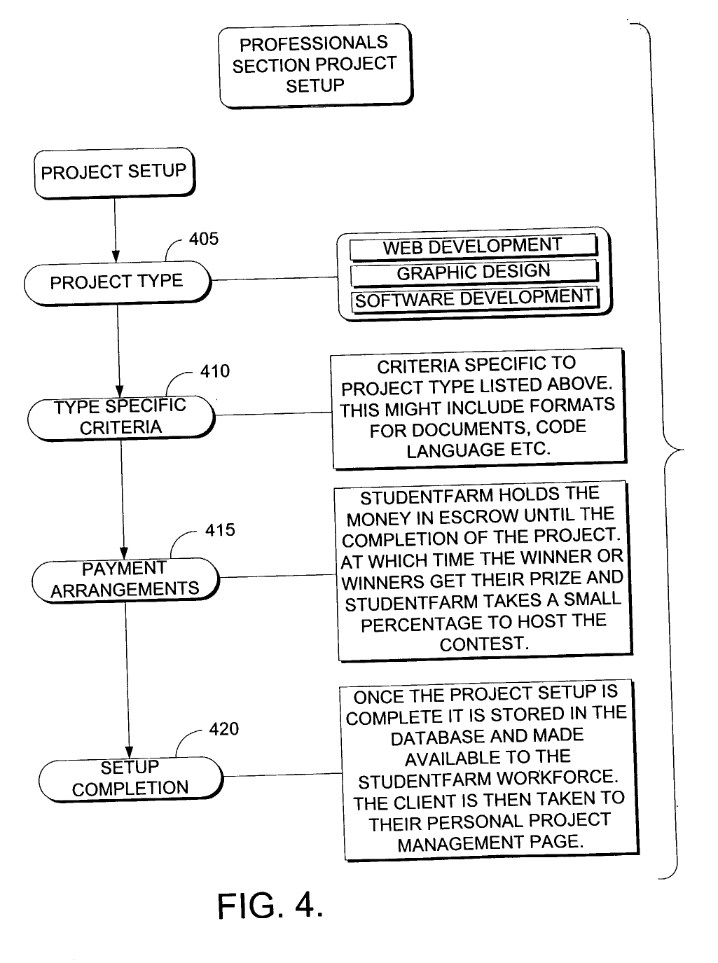

In operation, a professional defines a project within the forum, by utilizing a client computer such as shown in FIG. 1, to configure and provide project parameters that are stored in a database server 102. The project is first defined by a project setup process illustrated in FIG. 4 and generally designated as 400. A professional proceeds with the project setup 400 as follows. After the professional logs into the project center of the site, [s]he selects the project type at step 405. The project type can be a selection from a variety which may include, but is not limited to, web development, graphic design, or software development. Next, the professional adds type specific criteria at step 410 to qualify the project. Type specific criteria can include, but are not limited to a myriad of constraints and guidelines, beginning and ending dates, formats for documents, code language restrictions, as well as awards for the top candidates. The Professional can also specify at step 410, for instance, the maximum or minimum number of entries, interim deadlines, project expectation descriptions, terms and conditions requiring acquiescence, and response time requirements as type specific criteria. At step 415, the professional specifies payment arrangements. In an embodiment of the present invention, the web-site owner could hold any money awards in escrow pending project completion. Subsequently, the winner or winners receive their prize less a percentage to the web-site owner for hosting the contest. Although no money is required to change hands to facilitate the collaboration within a site, an illustrative embodiment is included whereby monetary or other types of awards provide mutual incentives to have many projects, timely completed, and reliably hosted.

The project setup is completed at step 420. At this point, the project along with the related specifications are stored in a database and made available for students to engage via the web-site, client application or other such interface. As stated earlier, students are merely the illustrated solution providers in this embodiment. There could be other individuals or organizations that provide solutions. After at least one project has been setup within the forum, that project and any others can be managed by a professional with the appropriate access rights.

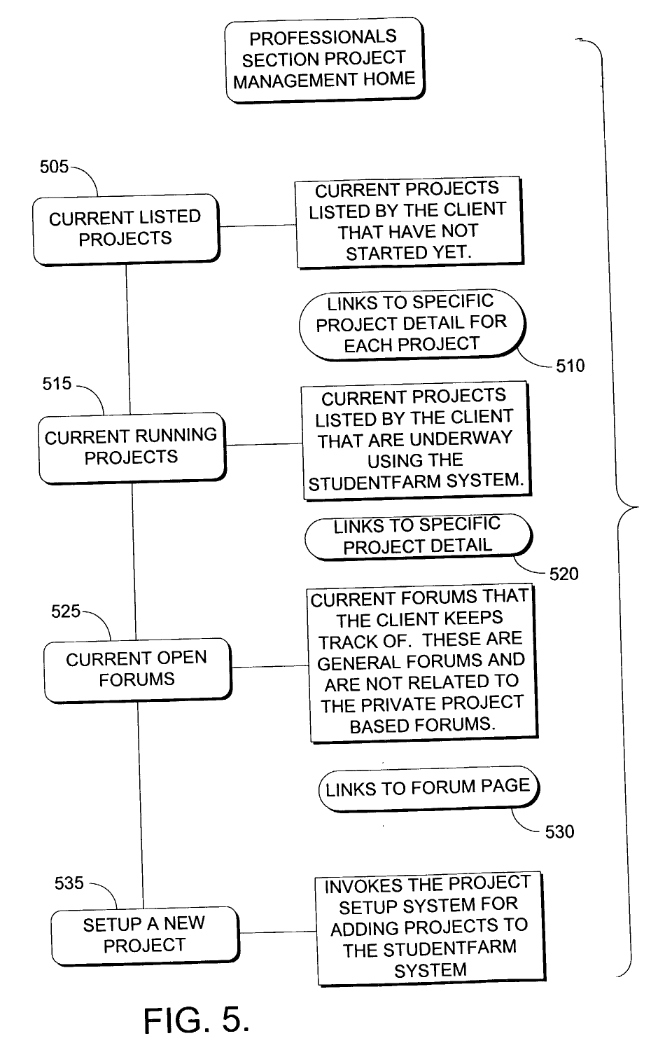

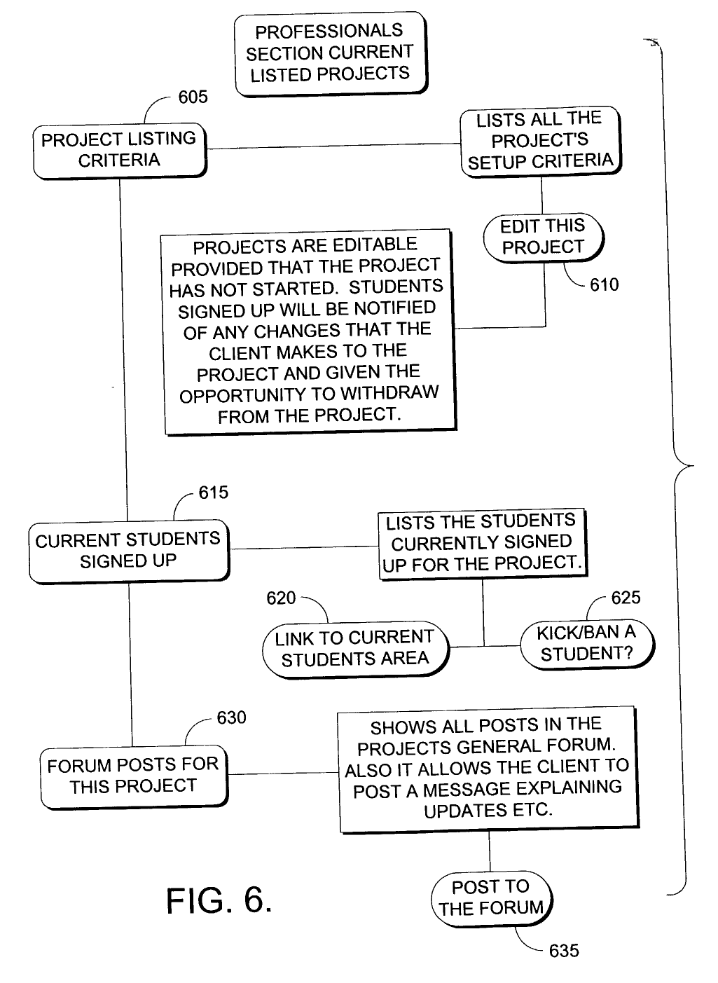

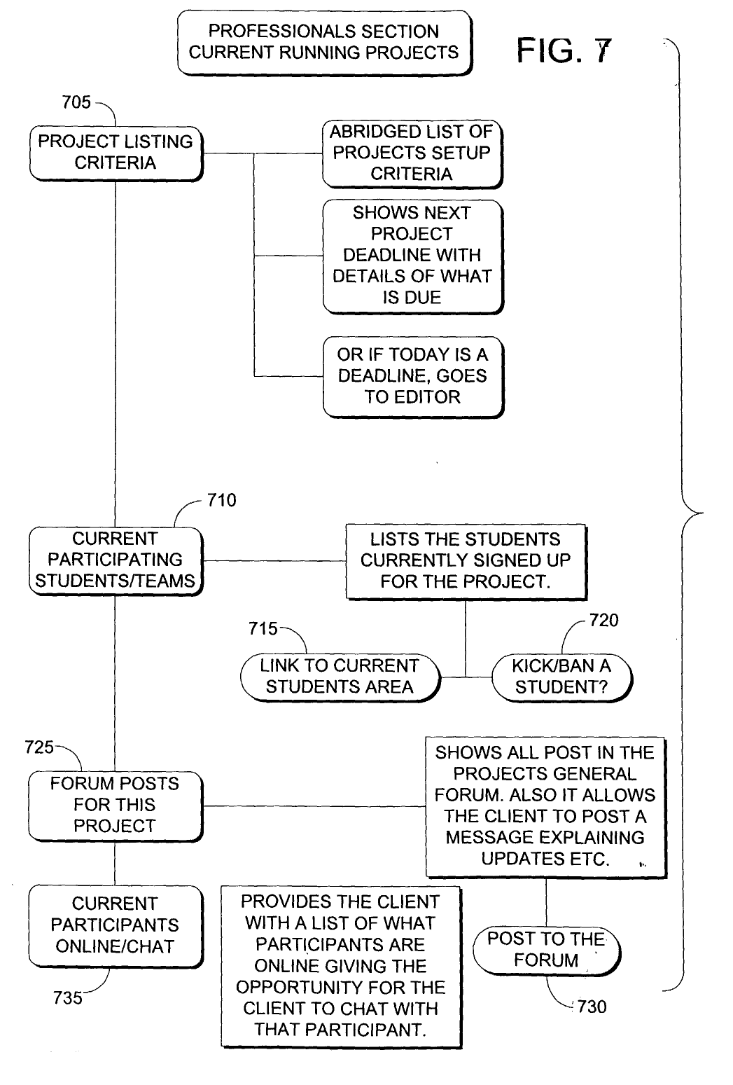

A professional can manage a project 215 on-line through a web-site, or any other mode of client access to the stored information, as illustrated by FIG. 5. From a project-management-content area 500, professionals can view their currently listed projects at step 505. These available options pertaining to currently listed projects will be further explained below with reference to FIG. 6. Furthermore, these listed projects are also linked to the specific details of the project at step 510, thus providing quick access by the professional to the details of the project. Current running projects can be accessed at step 515, and are further explained below with reference to FIG. 7. Current running projects includes a list of projects that are underway and being used in the system. As in the previous step, a professional can also access the details of any of the projects shown in the list. At step 525, a professional can view currently open forums. Links to forum pages or screens are provided, at step 430. These forums are general forums, that allow some degree of dialog between the users of the system, and are not related to the private project based forums, which are restricted to project participants. Finally, a professional has the ability to setup up a new project at step 535. The selection to setup a new project invokes the project setup procedures 400 of FIG. 4 that were previously discussed.

Current listed projects 505 is a sub-category of project management 700 as shown in FIG. 3, and will be discussed in detail with reference to FIG. 6. As shown, the options that are available for current listed projects 505, includes project listing criteria 605, current students signed up 615 and project forum posts 630. The project-listing-criteria area 605 lists a project's setup criteria. As such, projects can be edited at this stage as shown at step 610. In the event that a project is modified at this stage, students that are signed up for the changed projects will be notified of any changes that the professional makes to the project and will be given the opportunity to withdraw from the project. Professionals can also see which students are currently signed up for their project(s) by selecting the current-student-signed-up 615 option. In addition, a link to the current-student-signed-up 620 option area and an option to have students banned or removed from a project is also available at step 620. All posts in the projects general forum can be accessed by the forum posts for this project 630, which allows the professional to post a message explaining any changes, updates, etc. to the project.

Also available to a professional are features and options that are related to currently running projects 515, shown in FIG. 7. A project-listing-criteria 705 option is provided. This option contains an abridged list of the project's setup criteria, shows subsequent project deadlines detailing what is due and offers a link to enable the editing of project criteria as needed. An option relating to current-participating-students/teams 710 is provided for the current running projects 700 and allows the listing of students currently signed up for related projects. This option further includes the ability to link to an area that lists current students, current-students area 715 and the ability to remove a student at step 720. It is also possible from a forum-posts-for-this-project 725 option, to shows all messages or solutions posted in the project's general forum, while also allowing the professional to post messages directed to student participants, such as to explain project changes, updates, etc. Another option that is provided for a professional is the current-participants-online/Chat 735 option, which provides the ability for the professional to chat with participants that are online at that point in time. In other words, this option provides the professional with an opportunity to communicate directly with students. Those skilled in the art understand that chatting and its alternatives including but not limited to instant messaging, voice over IP, video conferencing, etc.

Even prior to students participating in a posted project 215, a moderator can begin to track the project 215 and to provide the tools and support to facilitate interaction among participants.

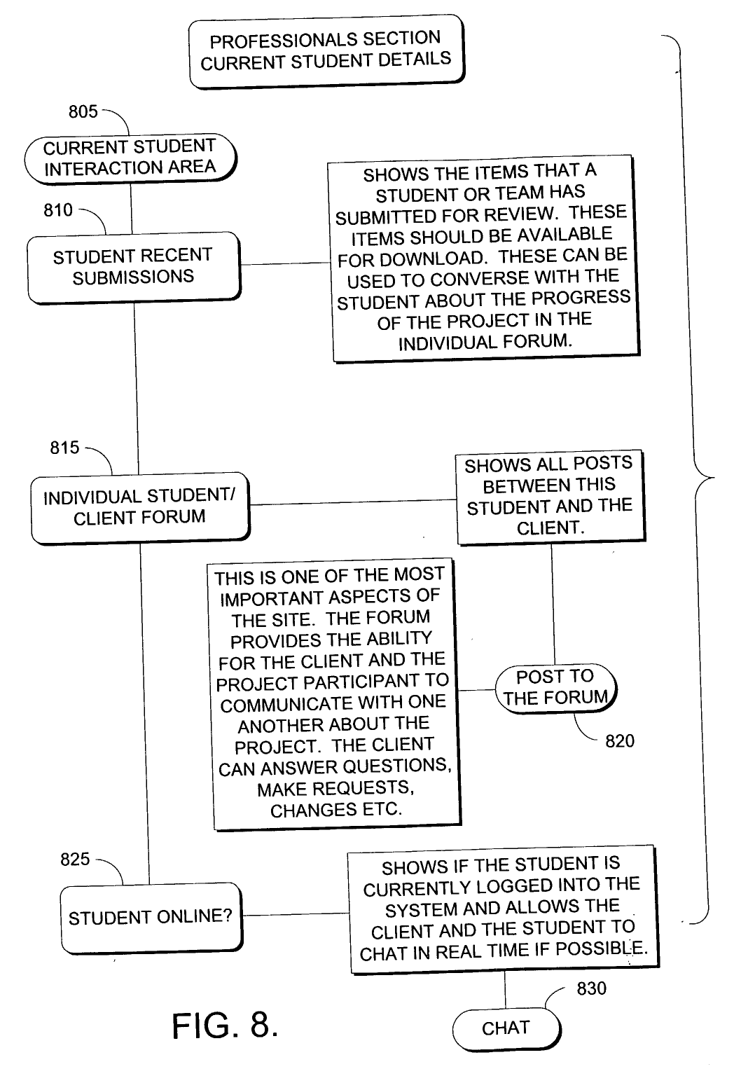

FIG. 8 depicts the current-student-details area, generally designated as 800. There is provided, a current-student-interaction area 805. Within this area it is possible to perform functions relating to recent submissions, individual forums and online students. A recent-submissions option 810 shows items that a student 205 or team 225 has submitted for review by a professional. These items can be made available for download. All posts between a student 205 and respective professionals 220 can be viewed using the individual-student/client forum option 815 shows. These posts can provide a transcript and benchmark that the client can use to keep the project progressing towards a solution. It should be particularly noted that the forum of the present invention, provides the ability for the professional 220 and the project participant 205 to communicate with one another about the project 215. The professional 220 can answer questions, make requests, changes, etc., while the student 205 can solicit feedback, ask narrowing questions, and present issues etc. Finally, there is the student-online 825 option, which serves to detect the presence of a student that is currently logged into the system at the same time as the professional. If so, then the professional 220 can communicate with the student 205 via chat or other means as previously discussed.

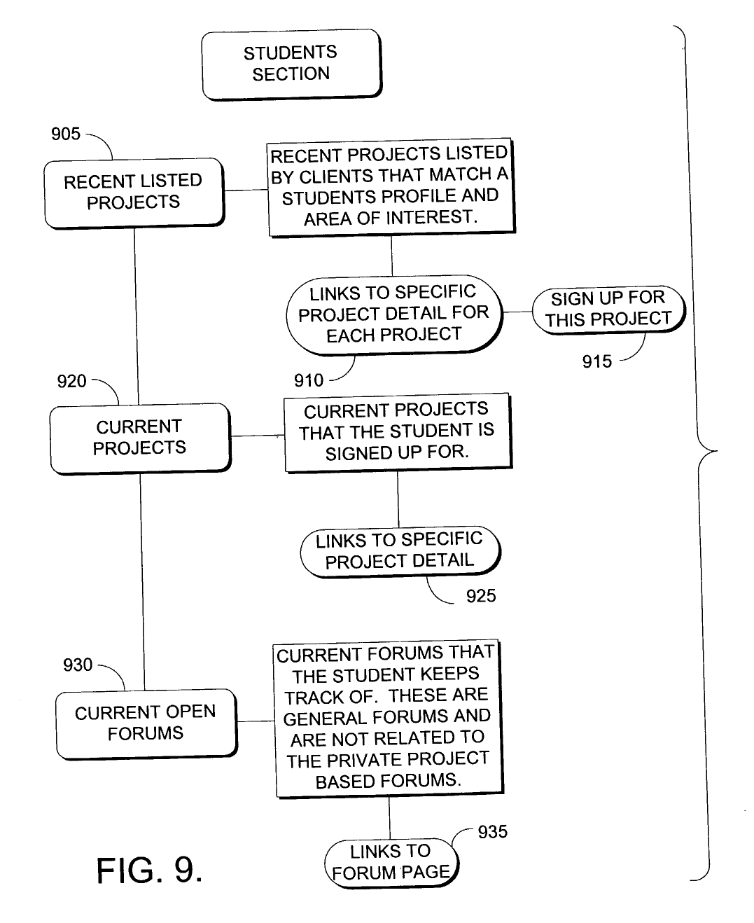

We now turn to the second class of users of the present invention, along with the some related functions and features that are available to the class. That is, the student's section 900, which is shown in greater detail in FIG. 9. A student has options related to recently listed projects, current projects and currently open forums. A recent-listed-project 805 option, allows the display of recent projects listed by professionals that match a student's profile with an area of interest. The recent-listed-projects 905 option, provides links to specific project details for each project, identified as 910, as well as a link to signup for the project, identified as 915. The current-projects 920 option shows the projects for which a student is currently signed up and includes links to specific project details 925. Finally, there is a current-open-forums 930 option that shows current forums that the student 205 keeps track of. Theses are general forums and are not related to private forums. The forum page 935 cab be accessed form the current-open-forums area 930.

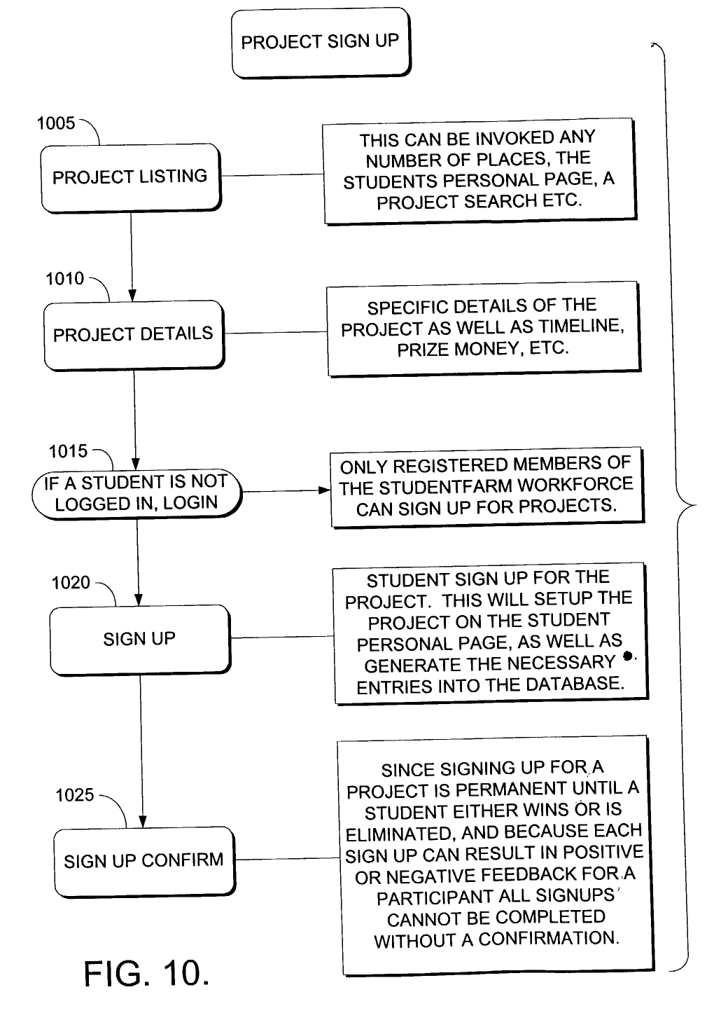

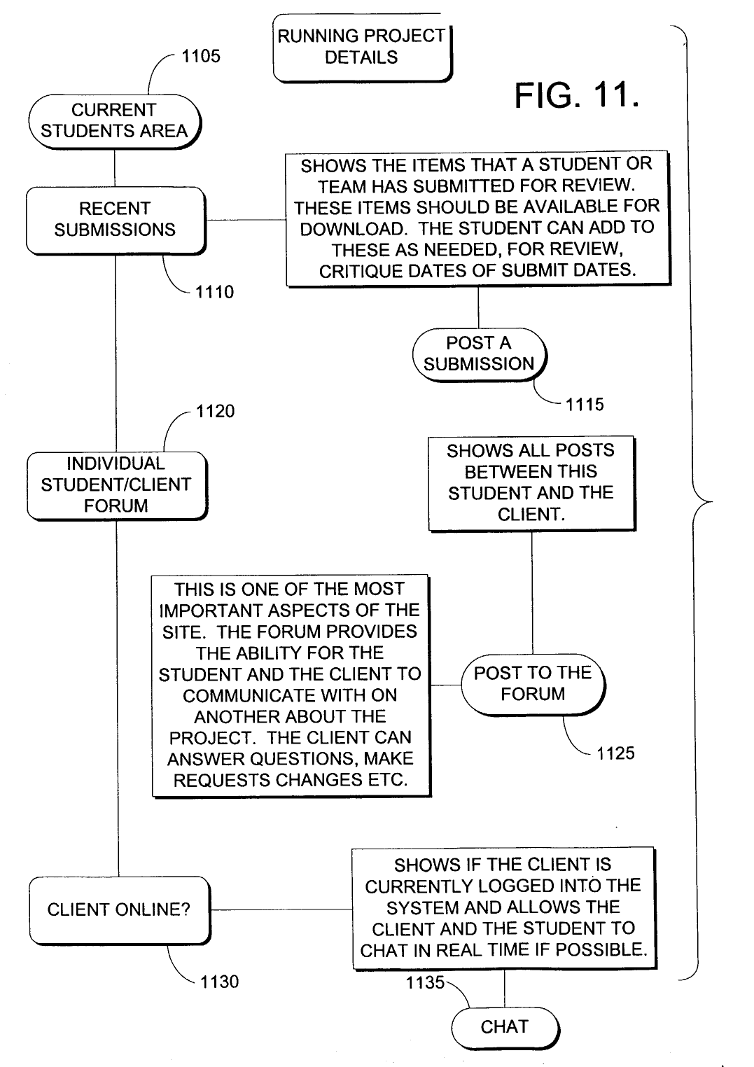

As previously discussed, a student 205 can participate in a project within the forum by signing up for a project. In an embodiment of the present invention the student will follow a signup process outlined in FIG. 10, and generally referenced as 1000. The student first reads a project listing at step 1005, followed by the project details at step 1010. The project details includes information such as timeline, prize money, etc. A verification of the status of a potential student is ascertained at step 1015. If the student is not logged in, [s]he must do so at step 1020. In a preferred embodiment, only registered members can signup for projects. A signup confirmation is provided at step 1025 because signing up can be permanent until a student 205 either wins or is eliminated. Because each signup can result in positive or negative feedback towards a student 205, all signups are not be completed without a confirmation.

Students 205 also have access to the details of running projects as illustrated in FIG. 11, and generally referenced as 1100. Running-project-details 1000 option includes a current-students-area 1105, which provides other features including viewing recent submissions, access to individual forums and allows live online chat. The recent-submissions-area 1110 option shows the items that a student 205 or team 225 has submitted for review and which can be available for download. The student 205 can add to these as needed to submit additional items for review, provide feedback regarding dates, submit anticipated segment completion dates, etc. A post submission link 1115 is available from the recent-submissions area 1110. An verification option 1130 is provided that lets the student know whether the professional 220 is online. If so, a chat or other form of communication can be initiated. The individual-student/client-forum 1120 option shows all posts between this student and the client and provides a link 1125 to submit a post to the forum.

As similarly noted above, the site of the present invention provides the ability for the students 205 to communicate with the professional 220. Students 205 in one areas of the world can communicate with professional 220 in another part of the world, permitting the invention to transcend geographic limitations. Similarly, the communication can transcend language barriers. Having a central location to collaborate, such as the forum of the present invention, enables students 205 to work on projects 215 independent of location, time, and language.

Since many possible embodiments may be made of the invention without departing from the scope thereof, it is understood that all matters herein set forth or shown in the accompanying drawings are to be interpreted as illustrative and not as limitations. For example, elements of the illustrated embodiment shown in software may be implemented in hardware and vice versa. Similarly, hardware and software components can be interchanged with other components providing the same functionality. What is claimed are all such embodiments as come within the scope and spirit of the following claims and equivalents thereto.

What is claimed is:

1. A method in a networked computing environment for providing a repository where one or more consumers can specify details and criteria for one or more projects, and where one or more providers can participate in responding to said projects with solutions, the method comprising:
providing a site in the networked environment wherein the consumer can specify the projects that they wish to have completed by the providers;
providing the providers with access to the site, wherein the providers can signup to participate in the projects;
accepting and storing on said site, solutions offered by the consumer; and
updating the site with status information on the projects, providers and solutions.

2. The method of claim 1, further comprising enabling the providers to collaborate with the consumers on providing solutions to the projects.

3. The method of claim 1, further comprising enabling the providers to collaborate with other providers on providing solutions to the projects.

4. The method of claim 1, further comprising enabling the providers to compete with other providers on providing solutions to the projects.

5. The method of claim 1, further comprising the step of maintaining a copy and an historical log of communications between said consumer and providers.

6. The method of claim 1, wherein said networked computing environment forum comprises:
a network sever;
a client computer;
said network server logically coupled to said client computer by a data network;
a web-site capable of facilitating data collaboration between multiple sets of entities accessible by said network server and via said client computer.

7. A method in a network computing environment for collaborating on a project task that was specified by a consumer on a web site, wherein said consumer is seeking proposals and solutions to said project task, comprising the steps of:
accessing a secured site wherein the project was previously described by the consumer;
linking to a detailed description of the project as specified by the consumer;
electing the project by singing up to participate; and
tracking the participation and solutions of one or more providers in the project.

8. The method as recited in claim 7, further comprising opening a forum to enable other providers to participate, in providing a solution to the project.

9. A method in a networked computing environment for specifying a project task on a web site, wherein said project task is to be completed by one or more providers, comprising:
setting up a project on the web site by describing attributes of the project comprising:
a project type identification;
one or more project specific criteria, including document formats, programming language, timelines and project rules; and
a payment arrangement if any payment will be made;
enabling the one or more providers to access and select the project task;
accepting and reviewing entries from one or more providers pertaining to the project;
viewing projects that were previously described; and
communicating with providers on the status of their solutions and updates if any to the project requirements.

10. The method of claim 5, wherein the viewing of projects that were previously described is the viewing of currently open and running projects.

11. A computer system having a processor, a memory and an operating environment, the computer system operable to execute the method recited in claim 1.

12. A computer readable medium having computer executable instructions for performing the method recited in claim 1.

13. A computer system having a processor, a memory and an operating environment, the computer system operable to execute the method recited in claim 7.

14. A computer readable medium having computer executable instructions for performing the method recited in claim 7.

15. A computer system having a processor, a memory and an operating environment, the computer system operable to execute the method recited in claim 9.

16. A computer readable medium having computer executable instructions for performing the method recited in claim 9.

17. A computer system in a networked environment adapted to provide an online site where one or more consumers can specify details and criteria for one or more projects, and where one or more providers can participate in responding to said projects with solutions, the system comprising:
a site specification component for providing a site in said networked environment wherein the consumer can specify the projects that they wish to have completed by the providers;
a site access component to enable the providers to access the site, whereby the providers can signup to participate in the projects;
a collaboration component to enable the providers to collaborate with the consumers on solutions to the projects;
a collaboration component to enable the providers to collaborate with other providers on providing solutions to the projects; and
a programmed component to enable the providers to compete with other providers on providing solutions to the projects.

18. The system of claim 17, further comprising a data logging component to maintaining a copy and an historical log of communications between said consumer and providers.
